(19) United States
(12) Patent Application Publication
(10) Pub. No.: US 2004/0031375 A1
(43) Pub. Date: Feb. 19, 2004

(54) Snares for snare drums

(76) Inventor: Julius John Hayden III, Covington, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/222,069

(22) Filed: Aug. 16, 2002

(51) Int. Cl. G10D 13/02

(52) U.S. Cl. 84/415

(57) ABSTRACT

Snares for snare drums which decouple tensioning from the dimension and shape of snare segments which contact the drum head. According to various embodiments, the snares include one or more tensioning members and a plurality of head contact members. The tensioning members may be connected to conventional snare strainer plates or end pieces. Some or all of the tensioning members support or carry one or more head contact members. The tensioning members may be wire, polymeric material or other desired material. The head contact members may be wire coils or helixes, formed of beads or other periodic or non-periodic shapes or structures or structured and configured as otherwise desired to be carried on tension members and cooperate effectively with the drum head for proper acoustical effect. The snares are adapted to be used with batter and bottom heads. Because snares according to the present invention decouple for snare tensioning from shape of head contact members, tuning is made easier and undesired deformation of the snares from over tensioning or other causes is reduced or eliminated.

The present invention relates to snares for snare drums.

Conventional snare drums, such as those manufactured by Premier, Pearl, Andante, Yamaha, Ludwig and others, feature one or more snares, each of which is positioned adjacent to a bottom (snare) head as found in most drums, and/or a top (batter) head as found in drums used by marching bands. The conventional snare is formed of a plurality of wire helix or coil segments, the ends of which are commonly welded directly to a pair of strainers or end pieces. The end pieces may be mounted on a snare support mechanism, which is in turn mounted to the drum shell. Typically, the end pieces are adapted to draw the wire segments under tension in a manner that allows their tension to be adjusted. The end pieces are also typically adapted to allow adjustment of the distance between the wire segments and the drum head. Such tension and height adjustment mechanisms are conventionally employed to tune the snare to optimum performance with the head.

Tuning of a snare drum involves optimizing acoustical performance of the snare, head and shell. A compression ring which retains the drum head on the shell typically contains a number of tensioning bolts which may be turned with a wrench or key to increase or decrease tension on the drum head. When the drum head is tensioned, and oftentimes when not, the snare requires adjustment in order to tune the drum to produce the desired sound. Tuning the snare is in some senses an art form. Usually, the drummer adjusts the height of a conventional snare relative to the head and then adjusts the tension until the wire segments are disposed at proper height and tension to vibrate for proper acoustical effect without unwanted “buzzing.”

Tensioning a conventional wire helix snare creates an undesirable secondary effect, however. When the drummer increases the tension on the segments, they elongate and thereby decrease in diameter in a manner similar to that in which a helix decreases in diameter as its length increases, given a substantially constant length of wire forming the helix. Accordingly, after a first height adjustment and subsequent application of tension, a second height adjustment may become necessary. Further iterative height and tension adjustments may become necessary. Additionally, when such snares are over tensioned, the wire coils may exceed their elastic limit and experience undesirable permanent deformation that causes them to sag or loosen relative to the drum head and the other snares welded to the end pieces, thus produce undesirable acoustics or harmonics and in most instances, necessitating the replacement of the snare assembly. Over tensioning can also subject the wire segments to undue abuse and additional tension imposed by drum sticks contacting the head during normal playing of the drum. This is especially true for drums where a snare is positioned against the top head on the side opposite the surface on which the drum sticks hit.

### SUMMARY OF INVENTION

The present invention provides snares which are adapted to be tensioned without affecting the structure of the snare that actually contacts the drum head. According to aspects of the present invention, snares include first, a tension member and second, a head contact member, so disposed that tensioning the tension member does not or only partially tensions the head contact member. As a result, the snare segments that span the end pieces may be tensioned as desired without affecting the diameter of the segments and thus their distance from the drum head. Decoupling the tensioning of the snare segments from the shape of their head contact members also eliminates the possibility of permanent deformation due to over tensioning and/or deformation from drum sticks hitting the drum head. Furthermore, because the tension members, which may be straight instead helix or coiled, feature a greater elastic constant than a helix or coiled member, tensioning may be more precisely controlled for improved tuning of the drum.

According to a preferred embodiment of the present invention, each snare segment is formed by a tension member or part of a tension member which is adapted to be laced on or otherwise retained under tension by strainer plates and end pieces, or simply end pieces of the snare. A plurality of head contact members, which may be wire coil or helixes, may be threaded on or otherwise disposed on the tension member or members. Alternatively, a plurality of beads may be threaded or otherwise disposed on the tension members. Any other desired shape of contact member may be suspended or supported by the tension member or tension members as desired. When the height of the snare relative to the drum head has been adjusted, tensioning of the snare may be accomplished without any further effect on height of the head contact members relative to the drum head or deformation due to the application of tension forces. Accordingly, tuning is made easier and any potential for permanent deformation is reduced or eliminated.

According to one embodiment of the present invention, one or more tension members may be laced through holes or other openings in the end pieces or strainer plates attached to the end pieces in continuous fashion, and the contact members threaded on segments of the tension member spanning the end pieces. When the end pieces are drawn apart to tension the snare, the low friction lacing of the tension member allows successive snare segments to be placed under substantially equal tension similar to the manner in which successive segments of shoe laces can be placed under substantially equal tension when shoes are laced.

According to another embodiment, the tension members comprise a plurality of segments, each of which is individually attached to the end pieces or strainer plates.

It is therefore an object of various aspects and embodiments of the present invention to provide drum snares which decouple or substantially decouple tensioning of the snare segments from the dimensions and shape of the portions which actually contact the drum head in order to increase ease of tuning and reduce possibility of deformation.

Other objects, features and advantages of the present invention will become apparent with respect to the remainder of this document.

### BRIEF DESCRIPTION OF THE DRAWINGS

FIG. 1 is a schematic perspective view of a snare drum with a single snare.

FIG. 2 is a schematic perspective view of a snare drum with dual snares.

FIG. 3 is a schematic view of a snare segment according to a preferred embodiment of the present invention.

FIGS. 4A and 4B are schematic views of a snare according to an embodiment of the present invention that includes multiple snare segments, each having a tension member and a head contact member.

FIG. 5 is a schematic cross-sectional view showing snare support and adjustment structure for a conventional top snare, as well as for snares according to the present invention.

FIG. 6 is a schematic cross-sectional view showing snare support and adjustment structure for a conventional bottom snare, as well as for snares according to the present invention.

FIGS. 7A, 7B and 7C show a snare according to another embodiment of the present invention in which a tension member is retained in laced, low friction relationship in channels and around retainers of end pieces for substantially equal tensioning of the snare segments.

FIG. 8 is a schematic cross-sectional view showing snare support and adjustment structure for a snare according to FIG. 7.

FIGS. 9A, 9B and 9C show a snare according to another embodiment of the present invention in which a tension member is retained in laced, low friction relationship through holes in strainers which are in turn connected to end pieces for substantially equal tensioning of the snare segments.

### DETAILED DESCRIPTION

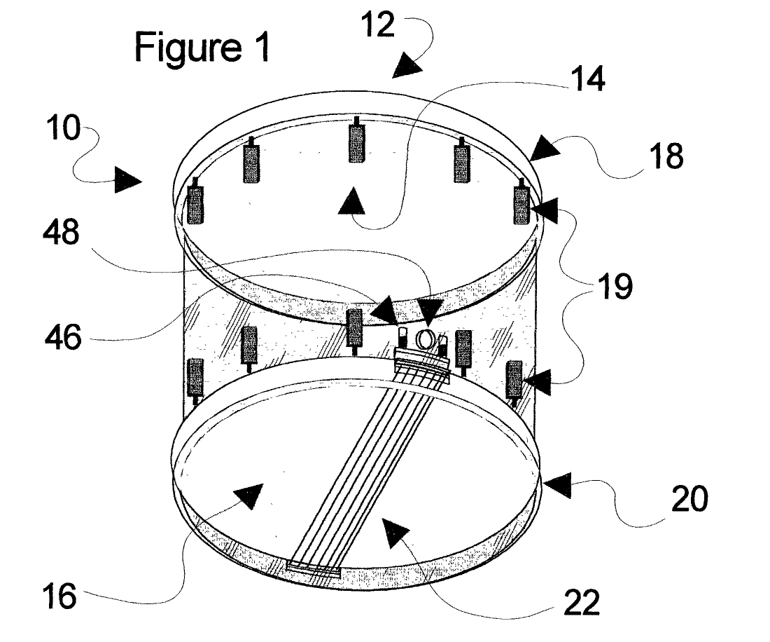

FIG. 1 is a schematic perspective view of a conventional snare drum with a single snare which is suitable for snares according to the present invention. Drum 10 is formed of a shell 12 and at least one and usually two heads. Top or batter head 14 is adapted to contact with drumsticks and may be formed of material different from the bottom head 16. Batter head 14 may be tensioned on shell 12 using a top compression ring 18 and tensioning bolts 19. Bottom head 16 may be tensioned on shell 12 using a bottom compression ring 20 and tensioning bolts 19. The snare 22, in this case a bottom snare, is positioned adjacent bottom head 16. It may be adjusted in height, 48 relative to bottom head 16 and adjusted in tension, 46 in conventional fashion for tuning. Compression rings 18 and 20 are typically drawn together in tension using a plurality of conventional tensioning screws 19, which may be adjusted with a key in order to tune the heads.

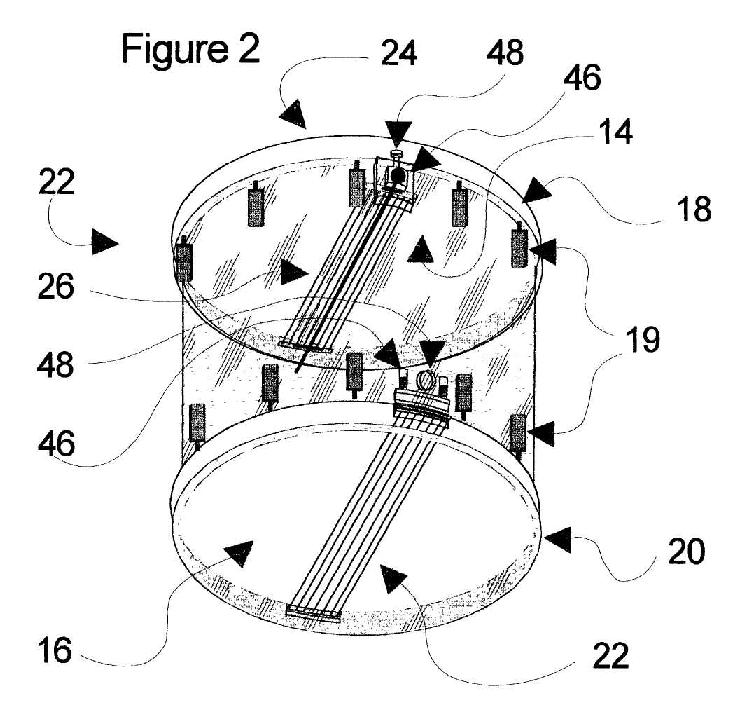

The dual snare drum 24 shown in FIG. 2 is similar in concept to the drum shown in FIG. 1 except for the addition of a top snare 26. Top snare 26 is typically adjustable in height relative to the top head 48, and in tension 46, for tuning.

Conventional drum snares include a number of wire helixes or coil snare segments, the ends of which are welded or otherwise attached to strainer plates which are in turn attached to end pieces in conventional fashion. The segments may alternatively be directly attached to the end pieces or attached to any desired structure. When the end pieces are adjusted in tension, the snare segments elongate. Because they contain a fixed amount of material, elongation causes helix or coil diameter to decrease, which decrease causes a change in distance between the snare segments and the drum head. Elongation and change in tension also causes a change in resonance of the portion of the snare actually contacting the drum head. The undesirable cross coupling between tensioning and snare segment dimension, shape and harmonics creates unfortunate tuning problems and deformation problems, among others, including those mentioned above.

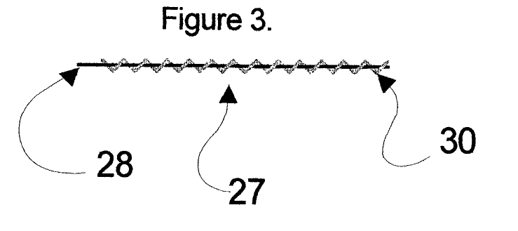

FIG. 3 shows schematically and conceptually a drum snare segment 27, according to a preferred embodiment of the present invention. Here, a tension member 28 supports a head contact member 30. The tension member may be polymeric cord or line, braided or fabric coil or line, metallic wire or braided structure, or any desired material having appropriate stress/strain, resonance, cost and durability features. Head contact member 30 may be a wire or other metallic or non-metallic helix or coil, a plurality of beads which may be interspersed with other members, a succession of pieces of larger diameter interweaved or interspaced with pieces of smaller diameter, or any other periodic, regular or irregular shaped structure which may be suspended on the tension members 28. In the preferred embodiment, head contact members 30 are formed of wire coils and the tension member is a polymeric cord or line. The diameters and elasticity characteristics of the tension member and the wire coils will vary depending on the desired acoustical effect sought.

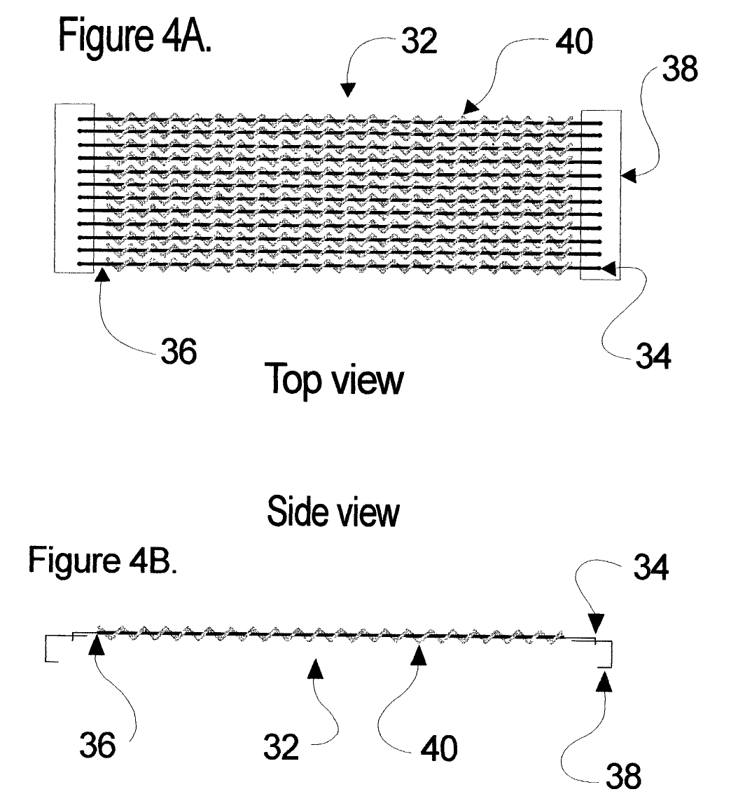

FIG. 4 shows a snare according to a first embodiment of the present invention. Here, snare segments 34 are formed of wire tension members 36 whose ends are welded, glued or otherwise affixed to strainer plates 38. Each wire tension member 36 supports and receives in threaded fashion a wire helix head contact member 40. The strainer plates 38 attach to and form a portion of the end pieces which are adapted to tension the snare segments 34 and adjust the snare 32 in height relative to drum head. Similar snare structures may be formed using tension members other than formed of wire, including polymeric line or cord, and by fastening in any desired fashion the non-wire or non-metallic tension members 36 to strainer plates 38, end pieces or similar structures.

In this and any other embodiments of the invention, the head contact members 40 are not affixed to the tension members and thus decoupled from any tension forces applied to the tension members. The length of the head contact members 40, is adjusted so that their length is less than the length of the smallest distance between the strainer plates 38 spaned by the tension members 36. When tension member or members 36 with head contact members 40 are tensioned according to the present invention, there is or can be slight increase in the length of such a compressed head contact member 40, due to contact with the head, and thus slight reduction in the diameter of the compressed head contact member 40 if it is helix or coil shaped, but that reduction is not deemed substantial within the meaning of the present invention. Accordingly, tensioning of tension members 36 and dimension and shape of head contact members 40 in such relationship are deemed to be decoupled or substantially decoupled within the meaning of the present invention.

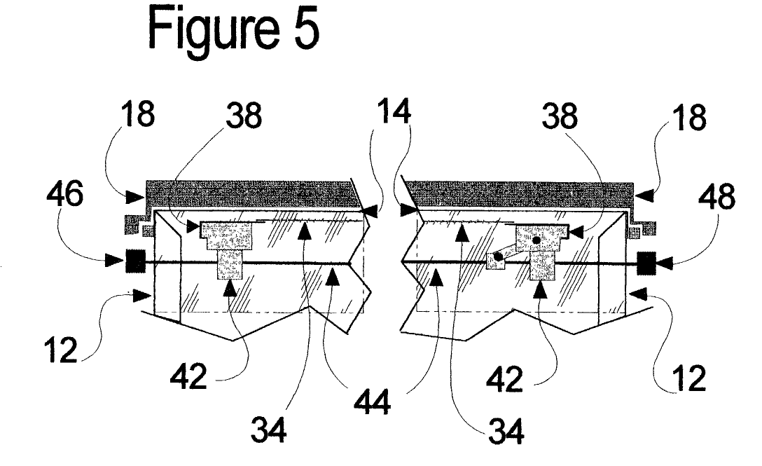

FIG. 5 shows end pieces 42 which may be used in snare drums that include snares according to the embodiment shown in FIG. 4. Shell 12, batter head 14, and top compression ring 18 are shown. A snare support 44 may be a rod or other elongated rigid structures spanning opposite sides of the shell 12. One or both end pieces 42 may be mounted on snare support 44 in sliding or threaded relationship so as to be adjustable in distance from each other using a tension adjustment mechanism 46 which may be conventional. A height adjustment 48 adjusts the height of both end pieces 42 and thus the snare segments 34 relative to the batter head 14 in conventional fashion. Conventional bottom snare height and tension adjustment mechanisms may be used for snares according to the embodiment shown in FIG. 5 which operate with bottom drum heads, as may any other desired form of adjustment mechanisms.

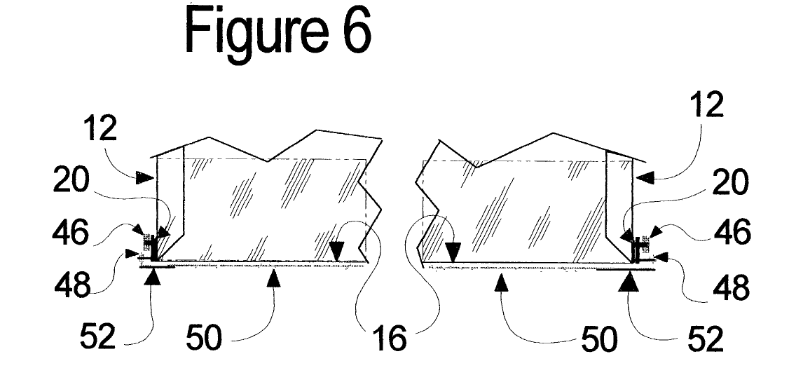

FIG. 6 shows a conventional bottom head adjustment mechanism which may be used with snares according to the present invention. Shell 12, bottom compression ring 20 and bottom head 16 are accompanied by a bottom snare 50 according to the structure shown in FIG. 4. Bottom snare 50 includes a pair of end pieces 52 according to the structure shown in FIG. 4 which may be adjusted in height relative to bottom head 16 using height adjustment mechanism 48. The tension of the snare may be adjusted using tension adjustment mechanism 46. Both height and tension mechanisms 48, 46 may be conventional.

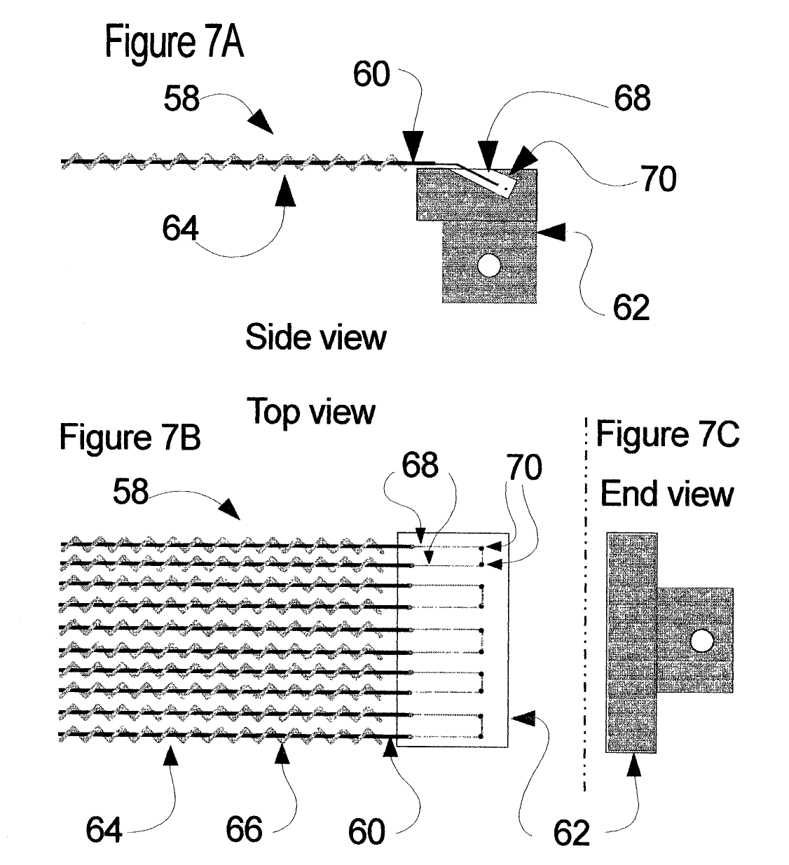

FIG. 7 shows another snare 58 according to another embodiment of the present invention. Here, a continuous tension member 60, which may be formed of polymeric line or cord or any other desired material, is disposed on end pieces 62 in laced relationship as shown in FIG. 7B. On each snare segment 64 which spans end pieces 62 may be found one or more head contact members 66. These may be formed of wire helixes or coils, or any other desired structure, as discussed above with respect to FIG. 4. Not every snare segment 64 need support a head contact member 66.

In the embodiment shown in FIG. 7, the end piece contains a number of channels 68, each of which features one or more retainers 70. Here the channels are U-shaped and include two retainers 70, but V-shaped or any desired channel shape may be used and one or more retainers 70 may be included. The tension member 60 extends in and is captured by channels 68 and extends around retainers 70 in a sliding, non-fixed or other low-friction relationship. Accordingly, when the end pieces 62 are drawn apart in order to tension the snare 58, substantially equal tension is placed on each of the snare segments 64.

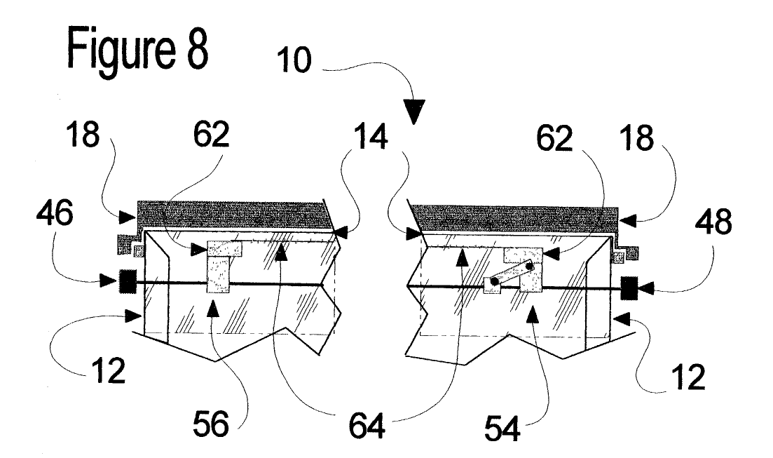

FIG. 8 shows in schematic side-cross section of the top head, the snare embodiment of FIG. 7 in a drum 10. End pieces 62 may be disposed in the drum 10 using the same sorts of support structures, height and tension adjustment mechanisms as discussed above.

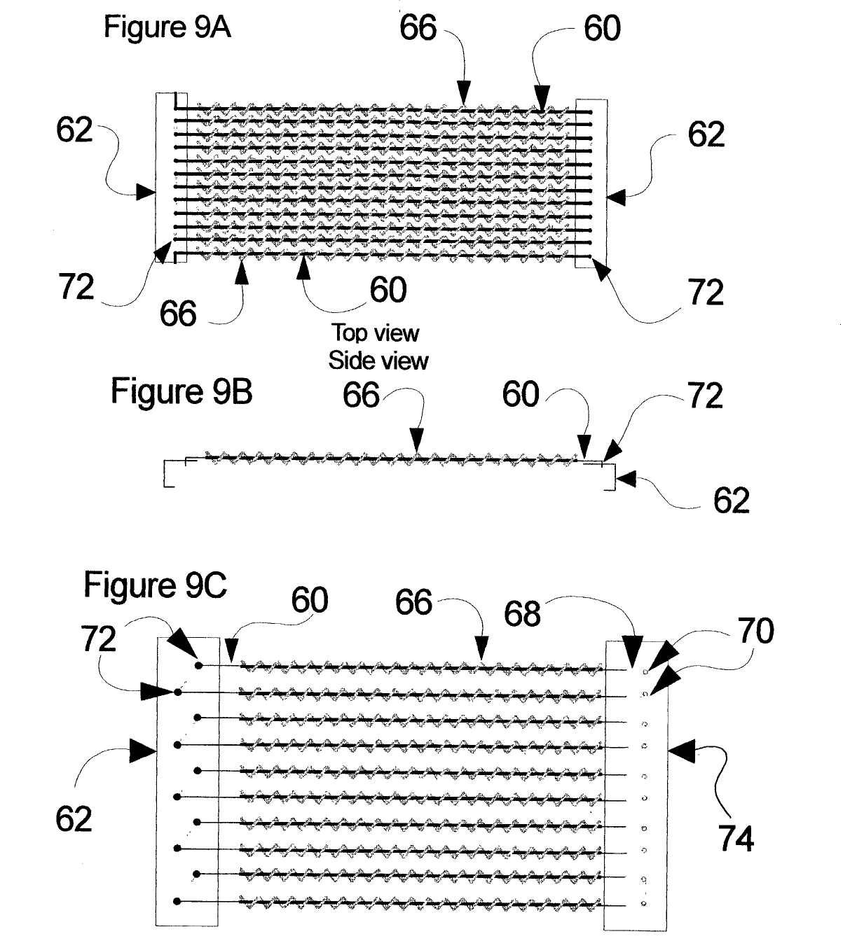

FIG. 9 shows a snare according to a third embodiment of the present invention. This snare is similar in some respects to the snare shown in FIG. 7. However, instead of using channels and retainers 68, 70, a continuous tension member 60 is threaded through holes 72 which may be formed in end pieces or strainer plates 62 which may be captured in end pieces 74. The centers of the holes 72, may be arranged in a single line, two lines, or more, positioned and oriented in end piece 62 as desired. The holes may contain bearings, may be U-shaped in cross section, and formed or fashioned as otherwise desired in order to create proper tensioning properties of tensioning member 60 relative to end pieces or strainer plates 62.

Any structure may be employed to produce snares according to the present invention which result in tensioning of the snare segments being decoupled from the shape of their portions which contact the drum head. Any desired material, shape, or configuration may be employed to carry out this invention and these results.

What is claimed is:

1. A snare drum comprising:
a. a shell;
b. a head; and
c. a snare positioned adjacent to the head, comprising:
1. at least one tension member disposed under tension in a direction substantially parallel to the head; and
2. at least one head contact member supported by the tension member, which head contact member is not under tension.

2. A snare drum according to claim 1 further comprising at least two end pieces, each end piece adapted to retain under tension a portion of a tension member.

3. A snare drum according to claim 2 in which the end pieces are adapted to retain under tension a continuous tension member which is laced relative to the end pieces.

4. A snare drum according to claim 3 comprising a plurality of contact members, each disposed on a segment of the tension member spanning the end pieces.

5. A snare drum according to claim 2 in which the end pieces are adapted to retain under tension a plurality of tension members, each spanning the end pieces.

6. A snare drum according to claim 1 in which at least one tension member is polymeric.

7. A snare drum according to claim 1 in which at least one head contact member is a metallic or non-metallic helix or coil which may be suspended on the tension members.

8. A snare drum according to claim 1 in which at least one head contact member comprises a plurality of beads.

9. A snare drum according to claim 1 in which at least one head contact member comprises a plurality of larger cross section segments and a plurality of smaller cross section segments.

10. A snare for a snare drum, comprising:
a. a pair of end pieces, at least one of which is adapted to be mounted in adjustable relationship to a snare support on a snare drum and which is adapted to retain and place under tension at least one tension member;
a. at least one tension member formed of non-metallic material;
b. a plurality of head contact members, each head contact member adapted to (i) be disposed at least partially about a portion of the at least one tension member and (ii) not be placed under tension when the tension member is placed under tension by the end pieces.

11. A snare according to claim 10 in which the end pieces are adapted to retain and place under tension a continuous tension member, the tension member laced relative to the end pieces, the head contact members disposed on portions of the tension member spanning the end pieces.

12. A snare according to claim 10 in which the end pieces are adapted to retain and place under tension a plurality of tension members, at least some of which are not retained by said end pieces in a laced relationship.

13. A snare according to claim 10 in which the at least one tension member comprises non metallic material.

14. A snare according to claim 10 in which the head contact members comprise metal coils.

15. A snare according to claim 10 in which the head contact members comprise a plurality of beads.

16. A snare according to claim 10 in which the head contact members comprise a structure adapted to at least partially enclose the at least one tension member and comprises a plurality of segments with larger cross sections and a plurality of segments with smaller cross sections.

17. A snare for a snare drum comprising:
a. pair of end pieces, each adapted to retain and place under tension a tension member in a laced relationship, and to be supported by a snare support structure;
b. at least one tension member retained under tension by the end pieces in a laced relationship; and
c. a plurality of wire coil head contact members, each threaded on a portion of the at least one tension member spanning two end pieces;
d. wherein each head contact member is not placed under tension when the at least one tension member is placed under tension by the end pieces;
e. whereby, when the tension of the snare is adjusted, the perpendicular distance between a head of a drum on which the snare is adapted to be mounted and the head contact members does not change substantially.

18. A snare end piece for a snare drum, comprising:
a. a first portion adapted to be mounted to a snare support of a snare drum;
b. a retaining portion connected to the first portion, the retaining portion comprising a plurality of openings through which a tension member may be threaded in a laced, low friction relationship;
c. whereby the end piece is adapted to place substantially equal tension upon sections of the tension member extending from the openings when the end piece and the tension member are disposed in a tension relationship.

19. An end piece according to claim 18 further comprising a strainer plate that includes a plurality of holes adapted for receiving the tension member.

20. An end piece according to claim 18 wherein the openings comprise channels formed in the end piece, each opening including at least one retainer adapted to reverse the direction of the tension member.
